(19) United States
(12) Patent Application Publication
(10) Pub. No.: US 2005/0025315 A1
(43) Pub. Date: Feb. 3, 2005

(54) Method and apparatus for secure communications among portable communication devices

(76) Inventor: Stuart S. Kreitzer, Coral Springs, FL (US)

Correspondence Address: AKERMAN SENTERFITT, P.O. BOX 3188, WEST PALM BEACH, FL, 33402-3188, US

(21) Appl. No.: 10/631,370

(22) Filed: Jul. 31, 2003

(51) Int. Cl. H04K 1/00

(52) U.S. Cl. 380/270

(57) ABSTRACT

A portable communication device (10) capable of operating in multiple modes includes a transceiver (38 and 44) and a processor (12) coupled to the transceiver. The processor can be programmed to establish (52) a symmetric traffic key in a first mode of communication between the portable communication device and a second portable communication device, switch (56) to at least a second mode of communication, and share (58) the symmetric traffic key between the portable communication device and the second multi-mode portable communication device in the second mode of communication.

### CROSS-REFERENCE TO RELATED APPLICATIONS

Not applicable

### FIELD OF THE INVENTION

This invention relates generally to secure communications, and more particularly to a system and method for establishing secure communications among portable communication devices having multiple modes or during a background mode.

### BACKGROUND OF THE INVENTION

Encryption of end-to-end communication is an increasingly important feature, particularly for wireless communication devices such as cellular phones and personal digital assistants (PDAs) to reduce the likelihood of eavesdropping. Encryption can be applied to voice (cellular interconnect or private call dispatch) as well as data. Using voice as an example, encryption algorithms typically employ a secret key that is used to encode voice on the source handset using an encryption algorithm. The coded voice stream can then be transmitted securely over a cellular communication system to a destination or target device. In order to decode the encrypted voice signal, the destination handset must use the same secret key that was used to encrypt the data and apply a decryption algorithm.

A classic problem in cryptography is securely sharing a secret key between two devices that can be miles or thousands of miles apart. Automatic Public Key (APK) exchange techniques are both a secure and convenient way to establish a secret key between two devices without transmitting the secret key in the clear over an insecure link. Diffie-Hellman and Elliptic Curve Cryptography are two well-known public-key algorithms that can be combined with protocols such as FNBDT (Future Narrow Band Digital Terminal) to implement APK systems. Although APK methods are convenient compared with alternatives such as manual key loaders, they are relatively slow as a result of being computationally intensive and because of the large keys needed for good security. To avoid this speed penalty, most secure devices use APK only to establish a symmetric (shared by both sides) traffic key and then revert to fast symmetric-key encryption algorithm such as DES or AES to encrypt and decrypt the traffic.

Because APK exchange is relatively slow on wireless devices, it noticeably delays call setup. Call set-up is the time elapsed between pressing the send or push-to-talk button and the call connecting with a secure traffic channel established. Excessive set-up tine is particularly harmful to the user experience on dispatch calls which are bursty in nature and are adversely affected by even small set-up delays. Thus, a system is needed that avoids unnecessary key exchanges and reduces or eliminates set-up delays for example when two portable communication devices already have an established secure link and the devices can operate in multiple modes.

### SUMMARY OF THE INVENTION

A method and apparatus for providing end-to-end encryption between communication devices can provide assurance against eavesdropping of sensitive information using a secure and simple method to exchange keys between two parties prior to beginning a secure communication. Such a secure and simple method to exchange keys is known as Automatic Public Key (APK). The disadvantage of APK is that it slows down the initial setup of a secure link, particularly on wireless devices that have limited computing power and throughput. As wireless devices add more and more functionality or modes such as encrypted cellular voice (interconnect), private call (dispatch), secure data, and WLAN, there is an opportunity to link key exchanges between these modes to re-use keys established by APK in one mode and thereby speedup initiation of secure communication for another mode.

By re-using traffic keys established by one mode of communication for other communication modes, the lengthy APK process can be avoided. Also, APK operations can be performed in the background in anticipation of upcoming secure calls to speed call set-up.

In one embodiment of the present invention, once a traffic key is established, it can be shared among multiple services on multi-mode devices to avoid redundant key exchanges. As an example, suppose the user of a cell phone capable of multiple communications modes (interconnect voice, dispatch voice, peer-to-peer data, etc or different protocol modes such as CDMA, TDMA, GSM, WLAN, etc) initiates a secure interconnect call to a target handset. The two phones can follow a protocol to determine capabilities, establish a symmetric traffic key using APK techniques, and set-up an interconnect call using end-to-end voice encryption. Once a symmetric traffic key has been established between the handsets, the key is securely stored in each handset and can be used by other services such as dispatch or peer-to-peer data. In another example, a device that is roaming between coverage areas using different protocols (CDMA, TDMA, GSM, WLAN or even operating in different frequencies) can continue a secure communication without having to re-establish the symmetric traffic key.

In a first aspect of the present invention, a method of establishing secure communications in a multi-mode portable communication device can include the steps of establishing a symmetric traffic key between the multi-mode portable communication device and a second portable communication device in a first mode of communication, switching to at least a second mode of communication, and sharing the symmetric traffic key between the multi-mode portable communication device and the second portable communication device.

In a second aspect of the present invention, a method of establishing secure communications among a plurality of portable communication devices can include the steps of storing information associated with a predetermined number of other portable communication devices, establishing a symmetric traffic key using an APK key establishment process between a first portable communication device and the predetermined number of other portable communication devices during a background mode of the first portable communication device, and establishing a secure communication session between the first portable communication and at least one among the predetermined number of other portable communication devices without further requiring the APK key establishment process.

In a third aspect of the present invention, a portable communication device capable of operating in multiple modes includes a transceiver and a processor coupled to the transceiver. The processor can be programmed to establish a symmetric traffic key in a first mode of communication between the portable communication device and a second portable communication device, switch to at least a second mode of communication, and share the symmetric traffic key between the portable communication device and the second multi-mode portable communication device in the second mode of communication.

In yet another aspect of the present invention, a portable communication device capable of operating in multiple modes can include a transceiver and a processor coupled to the transceiver. The processor can be programmed to store information associated with a predetermined number of other portable communication devices, establish a symmetric traffic key using an APK key establishment process between a first portable communication device and the predetermined number of other portable communication devices during a background mode of the first portable communication device, and establish a secure communication session between the first portable communication and at least one among the predetermined number of other portable communication devices without further requiring the APK key establishment process.

### BRIEF DESCRIPTION OF THE DRAWINGS

FIG. 1 is a block diagram of a portable communication device capable of sharing keys in multiple modes or establishing keys during a background mode in accordance with the present invention.

FIG. 2 illustrates a key exchange process in accordance with the present invention.

FIG. 3 illustrates another key exchange process in accordance with the present invention.

FIG. 4 is a flow chart illustrating a method of sharing keys between modes in accordance with the present invention.

FIG. 5 is a flow chart illustrating a method of establishing a key exchange in a background mode in accordance with the present invention.

### DETAILED DESCRIPTION OF THE DRAWINGS

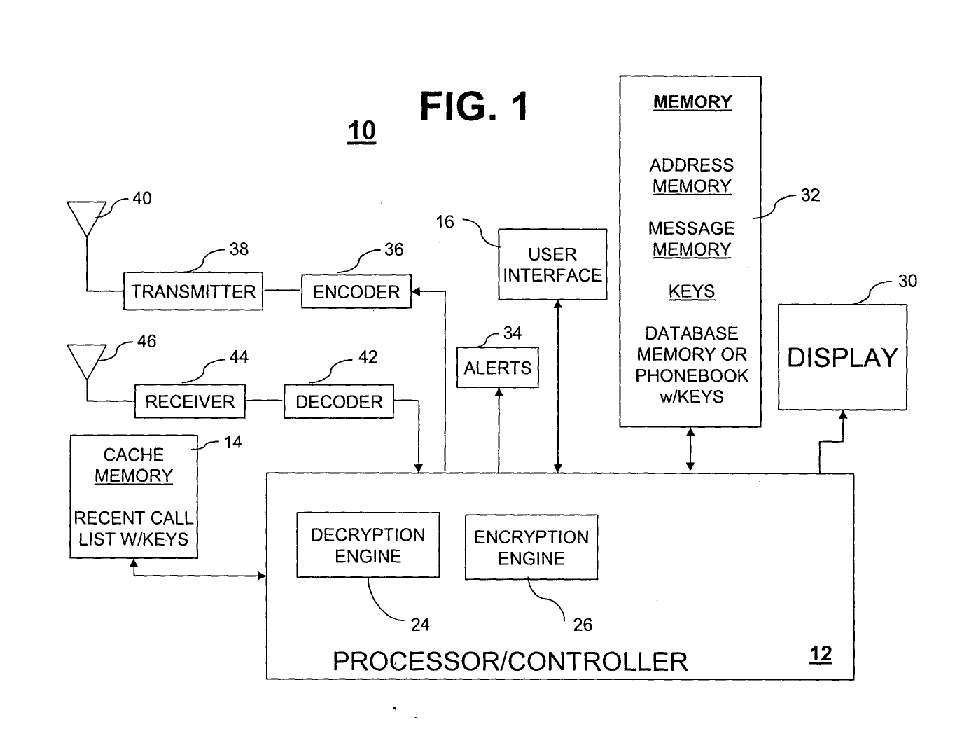

Referring to FIG. 1, a block diagram of a portable communication device 10 is shown. The device 10 can comprise, for example, a conventional cellular phone, a two-way trunked radio, a combination cellular phone and personal digital assistant, a smart phone, a home cordless phone, a satellite phone, a Motorola iDEN phone, or any device capable of operating in multiple mode in accordance with the present invention. A device operating across multiple modes can include a communication device able to operate in an interconnect voice mode, a dispatch voice mode, peer-to-peer data mode, a peer-to-peer voice mode, or among different protocol modes such as CDMA, TDMA, GSM, WLAN. The different modes can also include a two line phone that would otherwise require establishment of an APK exchange process to switch among phone lines on the same device to maintain secure communications. In this particular embodiment, the portable communication device can include an encoder 36, transmitter 38 and antenna 40 for encoding and transmitting information as well as an antenna 46, receiver 44 and decoder 42 for receiving and decoding information sent to the portable communication device. The receiver 44 and transmitter 38 would comprise a transceiver. The device 10 can further include an alert 34, a user interface 16, memory 32 and a display 30. The device 10 can further include a processor or controller 12 coupled to the display 30, the encoder 36, the decoder 42, the alert 34, a cache memory 14 and the memory 32. The memory 32 can include address memory, message memory, memory for keys and memory for database information such as a phonebook that can optionally contain the key related information. Optionally or alternatively, the cache memory 14 can include a recent call list along with associated keys for respective members of the list. Of course, to provide secure communications, the device 10 can also include a decryption engine 24 to decrypt encrypted information received by the device 10 and an encryption engine 26 to encrypt information sent out by the device 10. The engines 24 and 26 can be embedded in the processor 12 or reside external to the processor.

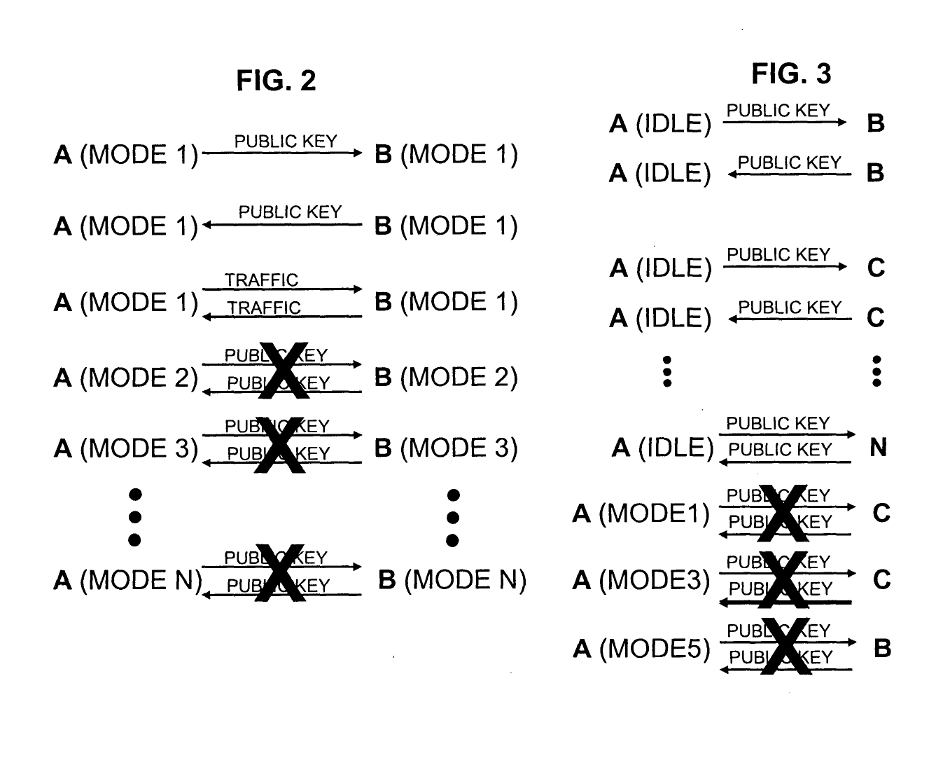

Referring to FIG. 2, a typical key exchange scenario in accordance with an embodiment of the present invention is shown. Device “A” can be the originating handset and device “B” can be the target handset. Although there can be other overhead information that can be sent back and forth between the devices as will be described below, this illustration has been simplified for clarity. To establish secure communications between device A and B in multiple modes, device A would need to send a public key in a first mode to device B. Device B would return a public key. The devices A and B then independently compute a symmetric (shared) traffic key using their own private keys along with the public key of the peer unit (or the other unit or more specifically, device A uses B's public key and device B uses A's public key) and commence secure communications in a first mode. Ordinarily, if the devices switched modes (from interconnect to dispatch, or from CDMA to GSM, or from line 1 to line 2, for example), they would normally need to re-establish secure communication by exchanging public keys again and by exchanging the computationally intensive exchange of traffic keys again. But as shown, since device A and device B have already exchanged keys in one mode, they can continue to communicate in a second mode, or a third mode, or any other number of modes without having to go through the APK exchange process. Devices A and B can even start a new communication session without having to go through the APK exchange process (as long as the respective keys are not expired as will be explained below). Further note in another embodiment that devices A and B do not necessarily need to be a multi-mode devices to take advantage of several concepts herein. For example, establishing a new communication session among devices having already exchanged keys would benefit by not needing to go through the APK exchange process again.

Referring to FIG. 3, another typical key exchange scenario in accordance with another embodiment of the present is shown. In particular, this scenario illustrates how a device such as device “A” can establish a key exchange in an idle or background mode with a predetermined number of other communication devices (“B” through “N”) to speed up the secure communication process. The keys and other associated information required to establish the key exchange and eventual secure communication with devices B-N can be stored in a phonebook or in cache memory as will be further detailed below. Device A can exchange public keys and traffic keys with device B, device C, or any other number of devices. Once the exchange is done, when device A originates a secure communication to device C in mode 1 (or any mode), the secure communication does not require the APK exchange process. Likewise, as described above, to switch modes with device C would not require the APK exchange process. In addition, switching to another device such as device B would also not require the APK exchange process since the traffic keys have already been exchanged during a background or idle mode.

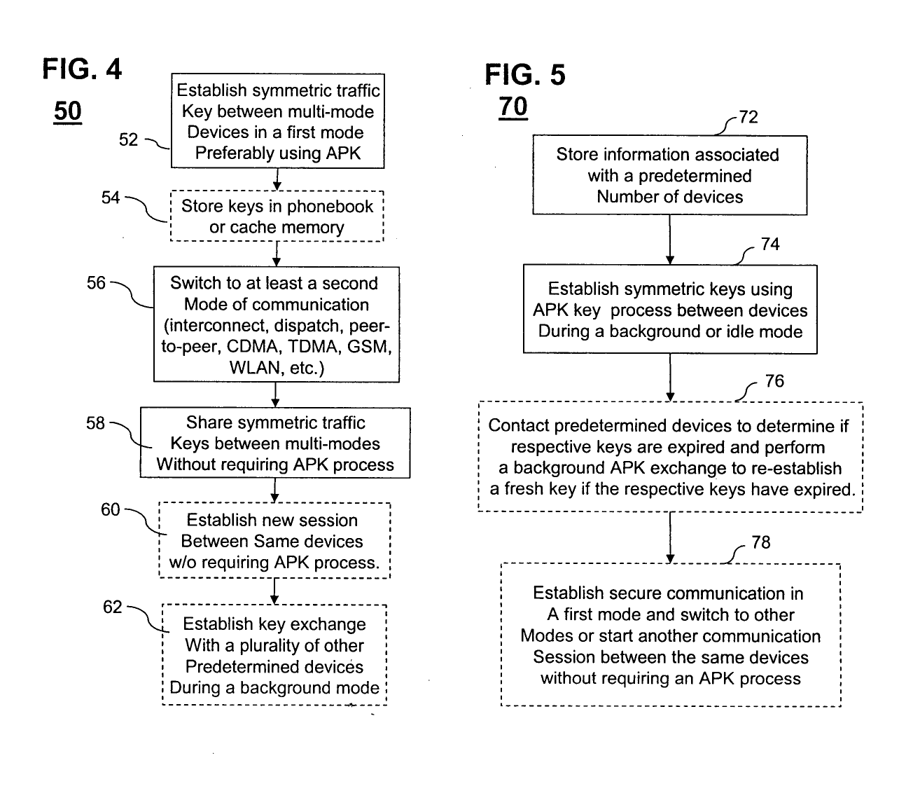

Referring to FIG. 4, a flow chart illustrating a method 50 of sharing keys and establishing secure communications in a multi-mode portable communication device in accordance with an embodiment of the present invention is shown. The method 50 can include the step 52 of establishing a symmetric traffic key between the multi-mode portable communication device and a second portable communication device in a first mode of communication, preferably using the APK exchange process and optionally storing the keys at step 54 (in either a phonebook, cache memory or other memory). The method can further include the step 56 of switching to at least a second mode of communication and sharing the symmetric traffic key between the multi-mode portable communication device and the second portable communication device at step 58. Method 50 can further optionally include the step 60 of establishing a new secure communication session between the same devices without requiring the APK process and establishing a key exchange with a plurality of other predetermined devices during a background or idle mode of the multi-mode portable communication device at step 62.

As noted above and with reference to the method 70 of FIG. 5, there are numerous methods for storing the traffic key in a portable communication device or handset and associating the stored key with a target device as shown at step 72. For example, the key can be associated with a phonebook record. When the user originates a secure call or when attempting to establish symmetric keys during an idle or background mode at step 74, the originating handset can send a capabilities exchange message containing its ID (phone number, dispatch ID, IP address, etc.), among other information to the target handset. The target handset, which can be equipped with a cache containing IDs, keys, and key expiration dates from recent secure call sessions, can receive the capabilities message, extract the ID and search the cache memory for an entry matching the ID of the originating handset. If a matching entry is found, the target handset will check the expiration date of the key to see if it is still valid at step 76. The existence of an unexpired key indicates that a usable key exists from a prior session and that the lengthy APK establishment phase is not necessary and the target handset will indicate as such in a capabilities response message back to the originator. Based on this “key OK” response from the target, the originator will skip the APK key establishment process at step 78.

Since a key established in one mode of communication (e.g. interconnect) is perfectly valid for another mode (e.g. dispatch) for the same set of communication devices, an APK process is only needed once when communicating using different modes as illustrated in method 50 of FIG. 4. A slight variation on this approach of associating keys with phone book entries is to instead use a cache of recently called secure numbers and associated keys. For example, the target handset could cache IDs, keys, and expiration dates for the 10 most recent secure calls. This may use less storage than associating keys with every phone book entry.

If the user attempts secure communications with a device that does not support secure communications for a selected mode, the attempt will fail during the capabilities exchange phase when the target handset is unable to confirm the required set of capabilities. For example, if a successful secure interconnect session is followed by an attempt at secure dispatch with a device that does not support dispatch or secure dispatch, the session will fail in the call establishment phase. Similarly, if the capabilities response indicates that the key has expired on the target, the originator is signaled that an APK procedure is required to establish a fresh key.

Since the traffic key will be used for multiple sessions, security of this key is a concern. It is the responsibility of the handset designer to secure the traffic key within the handset so that it cannot be compromised. Methods are well known in the art for securing keys using hardware and software. However, even with the key well protected, it is wise to have a security policy that causes the key to expire after an established period of time, perhaps as frequently as every 24-hours or a longer period of time such as every 30-days. In any case, the two handsets that agreed on a session key using APK can continue to use this traffic key for multiple services and enjoy the performance benefits of a pre-established key until the key expires.

Referring once again to FIG. 5, key exchange can take place in the background under some conditions to further speed up secure session initiation. For example, an idle handset can search through its list of recent secure calls and automatically contact these devices to check if keys have expired and, if so, perform a background APK to re-establish a fresh key. This background re-keying could be transparent to the user and is especially practical if packet data or WLAN capability exists. Background APK will save time when a future secure call needs to be initiated. In another scenario, if two devices having two lines are in secure communication on a first line, switching to a second line for both devices would not necessarily require an APK process if traffic keys were already exchanged on the first line.

It should also be noted that devices having a dispatch mode can greatly benefit from several of the embodiments of the present invention. In particular, secure dispatch performance is substantially improved because APK does not need to be performed after a dispatch session hang-time expires (typically about 6 seconds in Motorola's iDEN system). It should also be noted that another embodiment of the present invention can benefit peer-to-peer services such as talk-around systems (similar to FRS walkie-talkies). In this type of application the key can be exchanged using a cellular service (interconnect or dispatch utilizing a cellular network) and then stored for later use on an off-network service such as talk-around or FRS that may not have a facility for APK.

In light of the foregoing description of the invention, it should be recognized that the present invention can be realized in hardware, software, or a combination of hardware and software. A method and system for secure communications in a communication device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

Additionally, the description above is intended by way of example only and is not intended to limit the present invention in any way, except as set forth in the following claims.

1. A method of establishing secure communications in a multi-mode portable communication device, comprising the steps of:
establishing a symmetric traffic key between the multi-mode portable communication device and a second portable communication device in a first mode of communication;
switching to at least a second mode of communication; and
sharing the symmetric traffic key between the multi-mode portable communication device and the second portable communication device.

2. The method of claim 1, wherein the step of establishing the symmetric traffic key is achieved using Automatic Public Key exchange techniques by having the multi-mode portable communication device and the second portable communication device each independently computing the symmetric traffic key using their respective private keys along with a public key of a peer unit before commencing secure communications in a first mode.

3. The method of claim 2, wherein the Automatic Public Key exchange is implemented using public-key algorithms such as Diffie-Hellman cryptography or Elliptic Curve Cryptography.

4. The method of claim 3, wherein the Automatic Public Key exchange is implemented by combining public-key algorithms with a signaling scheme such as Future Narrow Band Digital Terminal protocol.

5. The method of claim 1, wherein the step of switching to the second mode from the first mode comprises switching among modes comprising interconnect voice, dispatch voice, peer-to peer data, and peer-to-peer voice.

6. The method of claim 1, wherein the step of switching to the second mode from the first mode comprises switching among modes comprising CDMA, TDMA, GSM, and WLAN.

7. The method of claim 1, wherein the method further comprises the step of storing the symmetric traffic key in a phonebook record associated with the second portable communication device.

8. The method of claim 1, wherein the method further comprises the step of storing a predetermined number of symmetric traffic keys in a cache memory associated with a predetermined number of other portable communication devices in recent communication with the multi-mode portable communication device.

9. The method of claim 1, wherein the method further comprises the step of establishing a new communication session between the multi-mode portable communication device and the second portable communication device without requiring an APK key establishment process.

10. The method of claim 1, wherein the method further comprises the step of establishing a key exchange with a plurality of other predetermined portable communication devices during a background mode.

11. A method of establishing secure communications among a plurality of portable communication devices, comprising the steps of:
storing information associated with a predetermined number of other portable communication devices;
establishing a symmetric traffic key using an APK key establishment process between a first portable communication device and the predetermined number of other portable communication devices during a background mode of the first portable communication device; and
establishing a secure communication session between the first portable communication and at least one among the predetermined number of other portable communication devices without further requiring the APK key establishment process.

12. The method of claim 11, wherein the step of establishing a symmetric traffic key using the APK key establishment process comprises contacting the predetermined number of other portable communication devices to determine if their respective keys have expired and performing a background APK exchange to re-establish a fresh key if the respective key has expired.

13. The method of claim 11, wherein the first portable communication device and the predetermined number of other portable communication devices are multi-mode portable communication devices and the method further comprises the step of establishing a symmetric traffic key between the first portable communication device and at least one among the predetermined number of other portable communication devices in a first mode of communication, switching to at least a second mode of communication, and sharing the symmetric traffic key between the first portable communication device and the at least one among the predetermined number of other portable communication devices in the second mode.

14. A portable communication device capable of operating in multiple modes, comprising:
a transceiver;
a processor coupled to the transceiver, wherein the processor is programmed to:
establish a symmetric traffic key in a first mode of communication between the portable communication device and a second portable communication device;
switch to at least a second mode of communication;
share the symmetric traffic key between the portable communication device and the second multi-mode portable communication device.

15. The portable communication device of claim 14, wherein the processor is programmed to establish the symmetric traffic key using Automatic Public Key exchange techniques.

16. The portable communication device of claim 15, wherein the Automatic Public Key exchange is implemented using a signaling scheme such as Future Narrow Band Digital Terminal protocol combined with public-key algorithms such as Diffie-Hellman cryptography or Elliptic Curve Cryptography.

17. The portable communication device of claim 14, wherein the processor is programmed to switch to the second mode from the first mode by switching among modes comprising interconnect voice, dispatch voice, peer-to peer data, peer-to-peer voice, CDMA, TDMA, GSM, and WLAN.

18. The portable communication device of claim 14, wherein the processor is further programmed to store the symmetric traffic key in at least one among a phonebook record associated with the second portable communication device and a cache memory associated with a predetermined number of other portable communication devices in recent secure communication with the portable communication device.

19. The portable communication device of claim 14, wherein the processor is further programmed to establish a new communication session between the portable communication device and the second portable communication device without requiring an APK key establishment process.

20. The portable communication device of claim 14, wherein the processor is further programmed to establish a key exchange with a plurality of other predetermined portable communication devices during a background mode.

21. A portable communication device capable of operating in multiple modes, comprising:
a transceiver;
a processor coupled to the transceiver, wherein the processor is programmed to:
store information associated with a predetermined number of other portable communication devices;
establish a symmetric traffic key using an APK key establishment process between a first portable communication device and the predetermined number of other portable communication devices during a background mode of the first portable communication device;
establish a secure communication session between the first portable communication and at least one among the predetermined number of other portable communication devices without further requiring the APK key establishment process.
